(19) United States
(12) Patent Application Publication
(10) Pub. No.: US 2006/0167913 A1
(43) Pub. Date: Jul. 27, 2006

(54) Converting an address to a hyperlink

(75) Inventors: Chi H. Tam, Bellevue, WA (US); William M. Hsu, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/044,402

(22) Filed: Jan. 27, 2005

(51) Int. Cl. G06F 17/00

(52) U.S. Cl. 707/101

(57) ABSTRACT

In a data structure such as an electronic document, a location such as an address is entered, rendered, or scanned for as part of text of the data structure. The location is identified and is converted to a hyperlink that targets an application program such as a website. When activated, the hyperlink takes a user to the application program.

### TECHNICAL FIELD

This invention relates to a hyperlink of a location such as an address, presented in a data structure which links to an application program.

### BACKGROUND

A user may use an application program such as a word processing application program (e.g., Word® word processing program by the Microsoft Corporation) or a scheduling application program (e.g., Lotus Notes® scheduling program) to enter an address of a particular location. When the address is entered, it is usually presented in clear text (i.e., text that is indiscernible from other data entered in an electronic document that is created by the application program.

Typically, if the user is interested in seeing a map of the address, the user first launches a desktop mapping application program, such as Streets & Trips™ mapping application, or goes to an online mapping website, such as the MapPoint® Maps & Directions website. The user may either type in the address, or perform a “copy and paste” operation of the address from the electronic document to the mapping application program or website. The two-step process of finding a mapping application program or website and manually entering information can unfortunately be prone to user input errors.

Certain application programs, such as application programs in the Office® productivity suite of application programs by the Microsoft Corporation, may use “smart tags” to identify an address entered as data in an electronic document and allow subsequent actions to be performed on the address. For example, an address marked with a smart tag may suggest adding the address to a contacts list; calling a map application program and displaying a map with the address; displaying driving directions to the address; and removing the smart tag associated with the address from the current application. Therefore, to create a map, the user clicks on the smart tagged address of an electronic document and further clicks on the option of drawing a map if a mapping application program is accessible by the electronic document. Unfortunately, this process also involves two steps as use of smart tags does not directly provide a map showing the address.

### SUMMARY

In a data structure such as an electronic document, a location such as an address is entered as part of text of data structure and is identified and is converted to a hyperlink that targets an application program such as a website. When activated, the hyperlink takes a user to the application program.

### BRIEF DESCRIPTION OF THE CONTENTS

The detailed description is described with reference to the accompanying figures. In the figures, the left-most digit(s) of a reference number identifies the figure in which the reference number first appears. The use of the same reference number in different figures indicates similar or identical items.

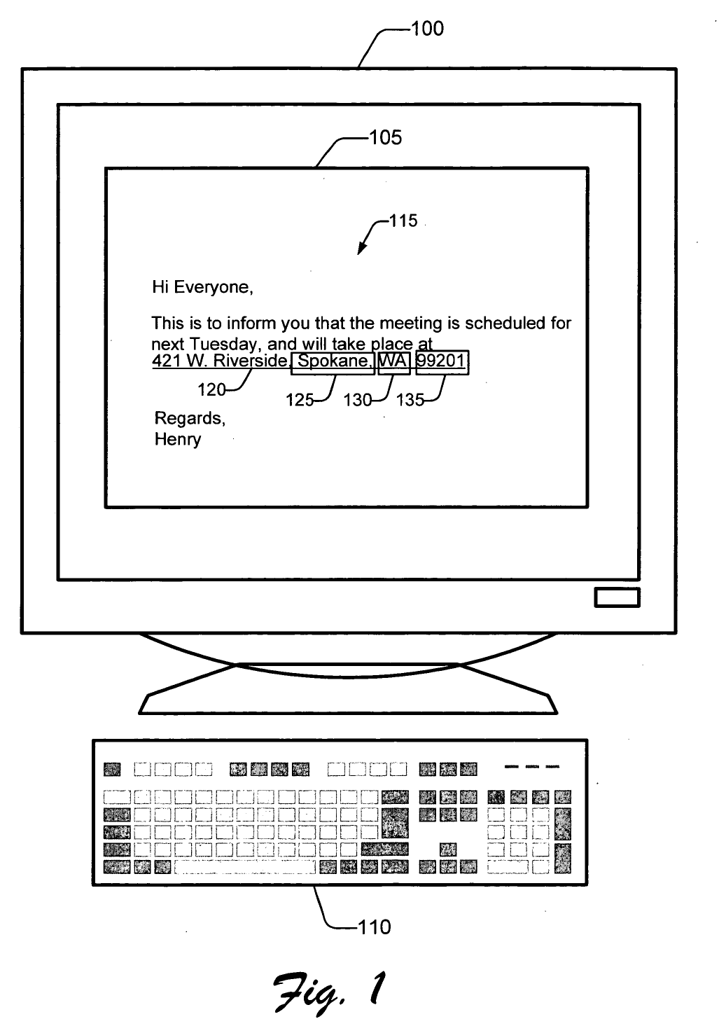

FIG. 1 is an illustration of a data structure such as an electronic document that includes an address which is converted to a hyperlink and displayed on a screen to a user;

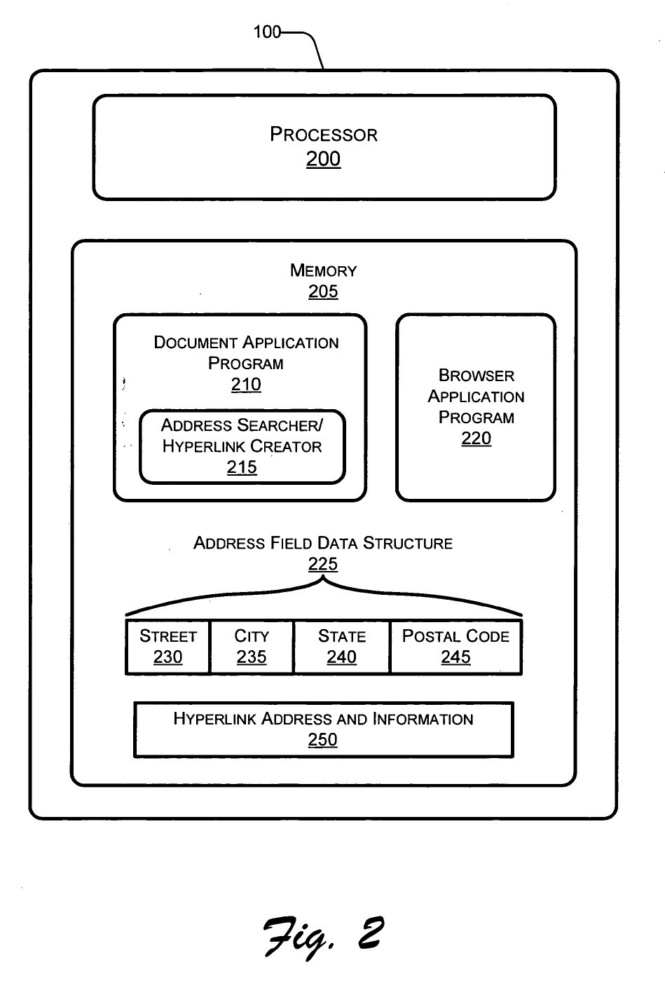

FIG. 2 is a block diagram of a computer or computing device that provides a data structure such as an electronic document, and includes data structures for a location or address field and a hyperlink;

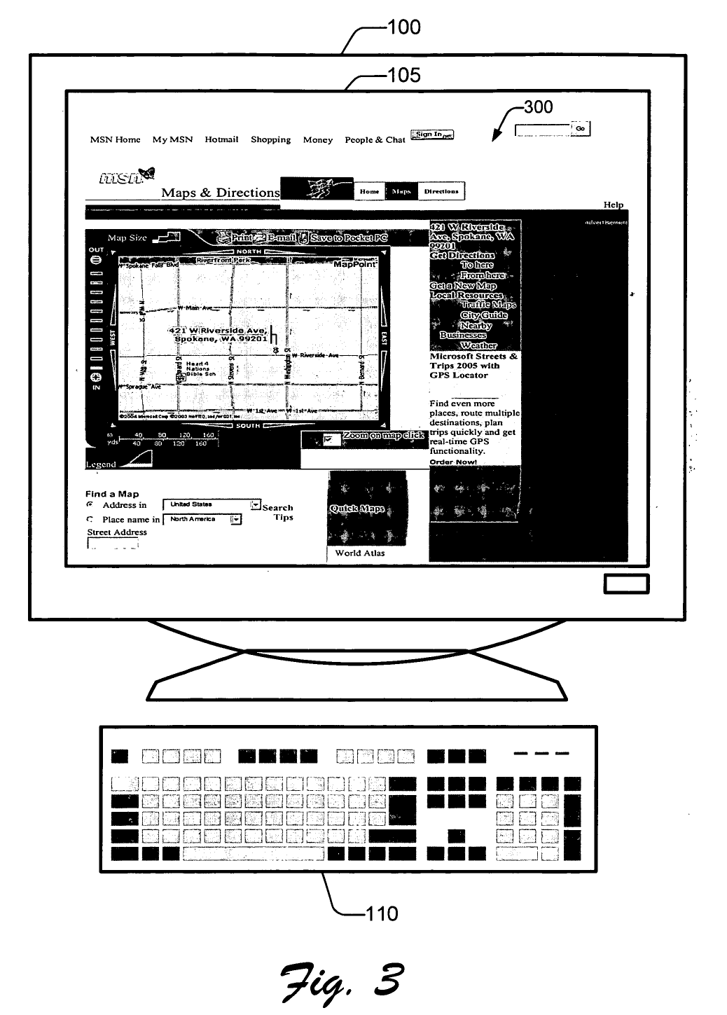

FIG. 3 is an illustration of a webpage of a map of an address as represented by an address field in a data structure such as an electronic document;

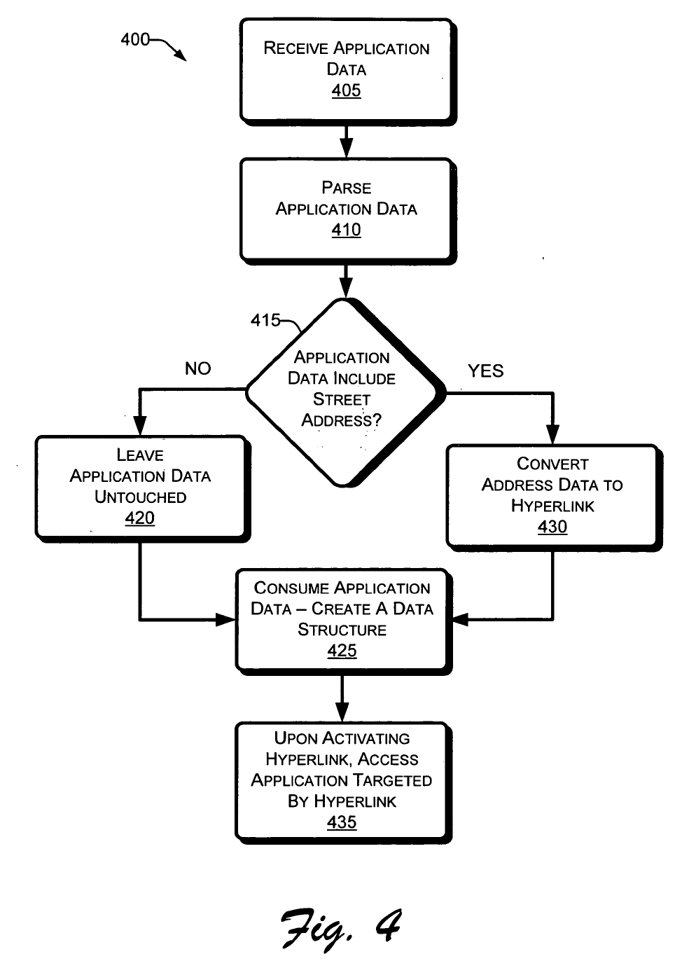

FIG. 4 is a flow diagram illustrating creating and using a hyperlink for an address included in a data structure such as an electronic document; and

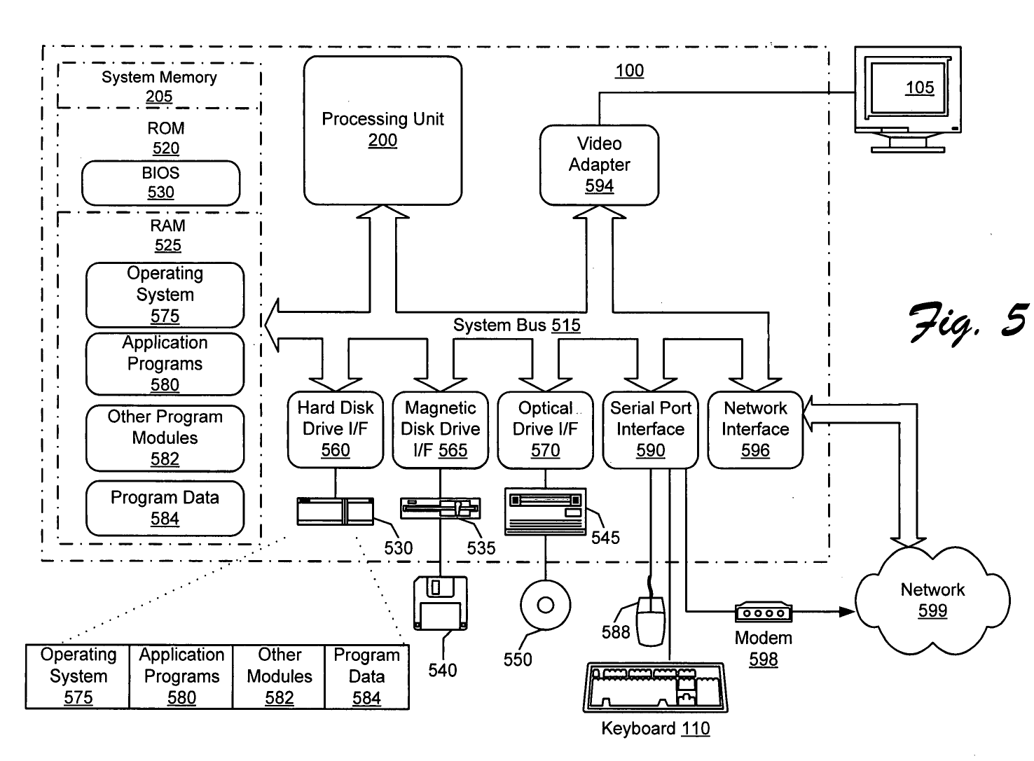

FIG. 5 is a block diagram of a detailed implementation of a computer or computing device in which an application program may be ran that creates an electronic document that includes a hyperlink feature.

### DETAILED DESCRIPTION

The following disclosure describes techniques in which an address in an electronic document is identified from other data in the electronic document, and creating a hyperlink of the address. When the hyperlink is activated, the user is directed to an application program such as a website.

FIG. 1 shows an electronic document that includes an address and is displayed on a computing device or computer. In other cases, a different data structure other than an electronic document is implemented. Computer 100 includes a screen 105 and is connected to or includes an input device such as a keyboard 110. An electronic document 115 is displayed on the computer 100 through display 105. Computer 100 may be one of various devices such as a desktop personal computer (PC), a laptop PC, a tablet PC, a personal digital assistant (PDA), or smart or feature phone.

The electronic document 115 is generated by one of various application programs that include, but not limited to, word processing programs, scheduling programs; email programs; and spreadsheet programs. The data in electronic document 115 may includes text data entered by a user through an input device such as keyboard 110.

As data is entered, a location or an address field 120 may be identified by the application program. In other cases, the address field 120 may be rendered by an application that looks for data representing locations or addresses. In other cases, a post processing step may be performed on a data structure by an application program which recognizes the address field 120. In other cases, the address field 120 may be representative of a name of a location such as an historical landmark, a commercial location (e.g., “shopping malls” or places of businesses).

The address field 120 may include a city subfield 125, a state subfield 130, and a postal code subfield 135. This example makes use of state subfield 130; however, a general term called “administrative unit” may be used in place of “state” to cover provinces, counties, and other units defined by other nations. When a complete address field 120 is entered, a hyperlink associated with the address field 120 is created by the application program. The hyperlink is targeted to application such as a particular website. Exemplary information in the hyperlink may include information to create a map showing the address represented by the address field 120; however, a targeted application may do something other than display a map. The hyperlink specifies a particular website address and information used by the website to create the map. An example of such a website address and information specified by the hyperlink is “http://mappoint.msn.com/421+W+Riverside+Ave+Spokane+WA+99201”.

The website address and information typically is not seen on the electronic document 115 by the user; however, the address field 120 as presented in electronic document 115 is identified as a hyperlink that may be activated by the user. The address field 120 may be identified as a hyperlink to the user by underlining, highlighting, the use of different fonts, or a combination.

In this example, the hyperlink of electronic document 115 particularly links to or targets the particular website in the World Wide Web (www). When the hyperlink is activated, a web browser such as Netscape® Navigator™ web browsing application program or Microsoft® Explorer® web browsing application program resident on computer 100 is called by the application program displaying the electronic document 115. The hyperlink may be activated by the user by performing a mouse click on the hyperlink.

In the example, address field 120 describes an address identified as “421 W. Riverside, Spokane, Wash. 99201”. Text in electronic document 115 may contain data that looks like an address such as “123 oaks”; however, such data may describe one hundred and twenty three oak trees. In other cases, an address may describe a number of addresses in the United States or the world. For example, the address “421 W. Riverside” may apply to different addresses in a number of cities.

To differentiate an address from other electronic document data and from similar addresses in different cities, the hyperlink is created when sufficient data is provided to complete address field 120 or to distinguish a particular address. City subfield 125 includes a specific city in which the address exists. Since there may be multiple cities having the same name, a state subfield 125 is included to further differentiate the address. Alternatively, a postal code subfield 135 may be used with or in place of the city subfield 125 and state subfield 130. Other examples of subfields that may differentiate an address include a country subfield, an international postal code subfield, a county subfield, and a province subfield. Address field 120 is considered complete when sufficient information is provided to identify a specific unique address. When address field 105 is complete, a hyperlink may be created by the application program creating the electronic document 115. It is contemplated that a distinguishable address may not have to be contained in a single line. For example, parsing over the document a context of a state may be inferred, which then can be used to make a street body or city combination unique which would not ordinarily be without the context.

Different scenarios exist in creating and using the hyperlink of electronic document 115. One exemplary scenario is to create the electronic document 115 where a user types out text which includes address field 120. The electronic document 115 may be sent in the form of an email or email attachment to another user. The electronic document is opened with an application program, and the hyperlink in the electronic is identified to the user. Furthermore, the hyperlink may be activated by the receiving user.

Another exemplary scenario is providing the electronic document 115 in the form of an email message that includes the hyperlink. When the email message is sent from a user to other users, the email with the hyperlink is opened by an application program such as Microsoft Outlook® scheduling application program. The application program allows the hyperlink to be activated by the receiving users.

In another exemplary scenario, an electronic document is created by an application program that does not provide a hyperlink for an address; however, the electronic document may contain data that describes one or more addresses. The receiving user opens the received electronic document using an application program. The application program identifies addresses in the opened electronic document and creates hyperlinks associated with the identified addresses. The hyperlinks then may be activated by the receiving user using the application program that opened the electronic document and created the hyperlinks.

In yet another exemplary scenario, an electronic document 115 is in the form of a web page of a website, where the webpage includes the address field 120. The address field 120 may identified to a user by a context menu that describes actions performed in association with the address field 120. The context menu may be presented to the user as an icon (e.g., mouse arrow) hovers over the address field 120. A particular action provided in the context menu is a hyperlink that targets another website that generates a map of the address associated with the address field 120.

FIG. 2 shows computing device or computer 100 in more detail. As discussed above, computing device or computer 100 may be one of various devices such as a desktop personal computer (PC), a laptop PC, a tablet PC, a personal digital assistant (PDA), or smart or feature phone. The exemplary architecture of computer 100 is further discussed in greater detail below in FIG. 5.

Computer 100 includes a central processing unit (CPU) or processor 200 and a memory 200. Processor 200 accesses memory 205 through a system bus (not shown). The memory 205 includes a document application program 210 that creates the electronic document 115 described in FIG. 1. In particular, an address searcher/hyperlink creator subcomponent 215 searches for addresses in an electronic document and creates the hyperlink associated with address field 120 in electronic document 115. Also included in memory 205 is a browser application program 215 that is called when the hyperlink in electronic document 115 is activated. Browser application program 215 particularly is used to target the particular website that creates a map of the address identified in address field 120.

Memory 205 further includes an address field data structure 220 representative of address field 120 of electronic document 115. Address field data structure 220 includes a street data field 225 that describes a particular street address; a city data field 230 which represents the city identified by city subfield 125; a state data field 235 which represents the state identified by state subfield 130; and a postal code field 240 which represents the postal code identified by postal code subfield 135. Memory 205 further includes a particular hyperlink address and information 245 associated with data stored in address field data structure 220. Hyperlink address and information 245 includes the website address of the website that creates the webpage of the map showing the address, and information used by the website to generate the map.

When browser application program 215 is called (specifically called by the activation of the hyperlink in electronic document 115), application program 215 accesses the data stored in hyperlink address and information 245. In particular, browser application program 215 looks for the web site address included in hyperlink address and information 245 in order to target or link to the particular website. Information in hyperlink address and information 245 is passed on by browser application program 215 to the particular website to generate the map.

FIG. 3 shows a webpage 300 of a map generated at a website. Web browser application program 215 links to the website, when a user activates a hyperlink in the electronic document 115. Webpage 300 may be generated by the website that the hyperlink is linked to, and displayed on screen 105. Alternatively, a separate mapping application may create the map and the map is saved by the website and displayed as webpage 300 on screen 105. Address information as contained in hyperlink address and information 245 is provided to the website or application such that the map is generated of the particular address as identified in address field 120 of electronic document 115.

Webpage 300 may include information such as advertisements. Webpage 300 may also present actionable user options such as hyperlinks to other websites and the ability to enter another street address through an input device such as keyboard 110. Such actionable user options may be performed in order to generate driving directions to the particular address.

FIG. 4 shows a process 400 to create and use a hyperlink based on an address in an electronic document. The process 400 is illustrated as a collection of blocks in a logical flow graph, which represent a sequence of operations that can be implemented in hardware, software, firmware, or a combination thereof. In the context of software, the blocks represent computer instructions that, when executed by one or more processors, perform the recited operations. The process 400 is described with reference to a computer further described below, that implements an application program that creates electronic document which contains the hyperlink for the address. Although described as a flowchart, it is contemplated that certain processes may take place concurrently

At block 405, data is received by an application program running on a computer. The data includes text that may or may not include data describing a particular location or address. The data may be entered by a user by typing out the data, cutting and pasting the data, or by some other way (e.g., rendering or a post processing step performed by an application program). In certain cases, the data is received by the application as an electronic document created by another application which may or not have created an address hyperlink.

At block 410, the received data is parsed-or processed into discernable data fields. In particular, the application program looks for data representative of a particular address. This may be performed by recognizing particular subfields such as a city subfield, a state subfield, and/or a postal subfield. When subfields related to an address are identified, an address data field is completed.

In certain cases, the parsed data does not include an address or does not identify data that is an address (i.e., following the NO branch of block 415). At block 420, the parsed data, and particularly parsed data that does not include an address, is left alone.

At block 425, the application program “consumes” the data and creates an electronic document. The electronic document may be presented to the user using the application program. The user may pass on the electronic document to other users who may open the document using the same application program or another application program.

If the parsed data includes data that identifies a particular address (i.e., following the YES branch of block 415), at block 430 the data identifying the address is used to create a hyperlink to link to or target a particular website. The particular website may either generate a webpage that shows a map of the address, or call up an application that creates the map which and saved by the particular website.

At block 425, a data structure such as an electronic document is created with the address hyperlink. The electronic document is presented to the user who may activate the hyperlink to access an application or a particular website. For example, a website or web service may call up a webpage and displays the map that shows the address. The user may pass the electronic document with the hyperlink to other users who may open the electronic document, activate the hyperlink, and access the website.

At block 435, if a hyperlink is available, the hyperlink may be activated by a user. When activated, an application is called such as a particular website. In the case of a website that is targeted by the hyperlink, a web browser application program may be used to go to the website. The website may generate the webpage that displays the map of the address. Alternatively, a different application other than a web browser may be invoked as a result of a click on the hyperlink, which can then use the address or other data to perform an action.

Computer

FIG. 5 shows an example implementation of computer or computing device 100 in greater detail. In particular, application programs may be implemented on the computer 100, that support the above described address hyperlink feature. The computer 100 may be configured with a Windows® brand operating system. The computer 100 includes processing unit or processor 200 described above, a system memory or memory 205 also described above, and a system bus 515 that interconnects various system components, including the memory 205 to the processing unit or processor 200. The system bus 515 may be implemented as any one of several bus structures and using any of a variety of bus architectures, including a memory bus or memory controller, a peripheral bus, and a local bus.

The memory 205 includes read only memory (ROM) 520 and random access memory (RAM) 525. A basic input/output system 530 (BIOS) is stored in ROM 520.

The computer 500 has one or more of the following drives: a hard disk drive 530 for reading from and writing to a hard disk or hard disk array, a magnetic disk drive 535 for reading from or writing to a removable magnetic disk 540, and an optical disk drive 545 for reading from or writing to a removable optical disk 550 such as a CD ROM or other optical media. The hard disk drive 530, magnetic disk drive 535, and optical disk drive 545 are connected to the system bus 515 by a hard disk drive interface 560, a magnetic disk drive interface 565, and an optical drive interface 570, respectively. The drives and their associated computer-readable media provide nonvolatile storage of computer readable instructions, data structures, program modules and other data for computer 100.

Although hard disk 530, removable magnetic disk 535, and removable optical disk 550 are described, other types of computer readable media can be used to store data. Other such media include magnetic cassettes, flash memory cards, digital video disks, Bernoulli cartridges, random access memories (RAMs), read only memories (ROMs), and the like. Additionally, the computer 500 may be configured to serve data stored on an independent system, such as a RAID (redundant array of independent disks) storage system, particularly when implemented as a terminal server.

A number of program modules may be stored on the hard disk 530, magnetic disk 535, optical disk 550, ROM 520, or RAM 525. The programs include a server operating system 575, one or more application programs 580 which include application programs 210 and 220 described in FIG. 2, other program modules 582, and program data 584.

A user may enter commands and information into the computer 100 through input devices such as keyboard 110 and a mouse 588. Other input devices (not shown) may include a microphone, joystick, game pad, satellite dish, scanner, and the like. These and other input devices are connected to the processing unit 200 through a serial port interface 590 that is coupled to the system bus 515, but may alternatively be connected by other interfaces, such a parallel port, game port, or a universal serial bus USB).

Monitor or screen 105 or other type of display is also connected to the system bus 515 via an interface, such as a video adapter card 594. The computer 100 has a network interface or adapter 596, a modem 598 or other means for establishing communications over network 599, such as an Internet connection. The modem 598 may also facilitate connection from a protocol decoder device. Screen 105 and input devices such as keyboard 110 and mouse 588.

### CONCLUSION

The above-described application program and electronic document describe converting data identified as an address to a hyperlink that links to a website that creates and/or saves a webpage of a map showing the address. Although the invention has been described in language specific to structural features and/or methodological acts, it is to be understood that the invention defined in the appended claims is not necessarily limited to the specific features or acts described. Rather, the specific features and acts are disclosed; as exemplary forms of implementing the claimed invention.

What is claimed is:

1. A method comprising:
receiving data that includes a location;
detecting the location in the received data;
converting the location to a hyperlink to an application program; and
creating a data structure that includes the hyperlink.

2. The method of claim 1 wherein the receiving data comprises receiving a second data structure.

3. The method of claim 1 wherein the receiving includes processing the data into address subfields that comprise a city subfield, an administrative unit subfield, and a postal code subfield.

4. The method of claim 1 further comprising presenting the data structure to a user wherein the hyperlink is identified to the user.

5. The method of claim 1 further comprising sending the data structure to an application program that opens the data structure and presents the hyperlink to a user.

6. The method of claim 1 further comprising providing the ability to allow the hyperlink to be activated such that a website is accessed.

7. One or more computer-readable media comprising computer-executable instructions that, when executed, perform the method as recited in claim 1.

8. One or more computer-readable media comprising computer-executable instructions that, when executed, perform the method as recited in claim 4.

9. One or more computer-readable media comprising computer-executable instructions that, when executed, perform the method as recited in claim 5.

10. One or more computer-readable media comprising computer-executable instructions that, when executed, perform the method as recited in claim 6.

11. A computer-readable medium having stored thereon a data structure associated with a hyperlink to a website comprising:
a first data field containing data representing a street address of an address;
a second data field containing data representing a city of the address; and
a third data field functioning to complete the address.

12. The computer-readable medium of claim 11 wherein the third data field comprises one or more of the following: an administrative unit subfield, a country subfield, and a postal code subfield.

13. The computer-readable medium of claim 11 wherein the data stored in the data structure is associated with the hyperlink.

14. The computer-readable medium of claim 13 wherein the hyperlink includes a website address of a website and information for the website to generate a map of the address.

15. The computer-readable medium of claim 11 wherein the hyperlink includes a website address of a website and information for the website to generate a map of the address.

16. An data structure comprising:
text data that is received and processed to be opened by multiple application programs; and
an identified location parsed from the text and numerical data that includes a hyperlink to an application program.

17. The data structure of claim 16 wherein the data structure is created from one of the following: a document created by a first application and opened by a second application; a received document; and a webpage.

18. The data structure of claim 16 wherein the application program creates one of the following: a map of the location, directions relative to the location, a list of other locations near the location.

19. The data structure of claim 16 wherein the application program is a website.

20. The data structure of claim 19 wherein the website saves a webpage that displays a map showing the location.
